(19) United States
(12) Patent Application Publication
(10) Pub. No.: US 2003/0016297 A1
(43) Pub. Date: Jan. 23, 2003

(54) Image sensing apparatus and image sensing method

(75) Inventor: Kazuyuki Shigeta, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/193,286

(22) Filed: Jul. 12, 2002

(30) Foreign Application Priority Data
Jul. 17, 2001 (JP) 2001-217122

(51) Int. Cl. H04N 5/335

(52) U.S. Cl. 348/304; 348/312; 348/222.1

(57) ABSTRACT

An image sensing apparatus includes a sensor which generates the image signal of an object, an operation unit which, when the signals of a plurality of frames of the object are read out from the sensor at the first resolution and the second resolution higher than the first resolution, operates the sensor so as to set intervals between read-out starts of image signals of the plurality of frames to be constant, and a controller which performs control so as to execute at least one of exposure adjustment and focus adjustment on the basis of an image signal read out from the sensor at the first resolution, and to execute image processing on the basis of an image signal read out from the sensor at the second resolution under adjusted conditions.

### FIELD OF THE INVENTION

The present invention relates to an image sensing apparatus and image sensing method and, more particularly, to an image sensing apparatus such as a digital camera, bar code reader, or fingerprint authentication system which forms moving and still images, and an image sensing method therefor.

### BACKGROUND OF THE INVENTION

A conventional image sensing apparatus performs auto focus (AF) and auto exposure (AE) processes prior to actual image sensing. Using image signals sensed at this time, the image sensing apparatus also executes various processes such as gain adjustment and exposure amount adjustment.

FIG. 16 is a block diagram showing the schematic arrangement of a conventional image processing apparatus. In FIG. 16, reference numeral 521 denotes a gain control amplifier (GCA) which controls the gain of an image signal input via a signal line 507; 522, an analog digital converter (ADC) which converts an output from the GCA 521 from an analog signal to a digital signal; 523 and 524, digital signal processors (DSP) which execute digital image processing for the contrast or γ conversion of an output from the ADC 522; 531, a frame memory which stores data processed by the DSP 524; 527, a blue matte generation circuit which generates a blue matte signal displayed on a monitor (not shown); 528, a switch (SW) which selects either one of an image signal from the DSP 524 and a blue matte signal from the blue matte generation circuit 527; 529, an on-screen display (OSD) for multi-displaying the processing state of the image processing apparatus main body by character information; 530, an LCD operation circuit for displaying an image on the monitor (not shown); 525, a quartz oscillator which generates a timing clock; and 526, a timing generator (TG) which generates various operation pulses to a sensor (not shown), the ADC 522, the DSPs 523 and 524, the LCD operation circuit 530, and the like on the basis of timing clocks from the quartz oscillator 525.

FIG. 17 is a timing chart showing the operation of the image processing apparatus shown in FIG. 16. In FIG. 17, VD1 and HD1 represent horizontal and vertical sync signals for writing a processed image signal in the frame memory 531; VIDEO IN, an image signal input to the image processing apparatus; V1 to V4, image signals representing respective images; VD2 and HD2, horizontal and vertical sync signals for reading out an image signal from the frame memory 531; VIDEO OUT, image signals which are output from the image processing apparatus and are represented by V1′ to V4′ in correspondence with V1 to V4; and OSD, a character signal generated by the OSD 529.

In the image processing apparatus shown in FIG. 16, the gains of the input image signals V1 to V4 are adjusted by the GCA 521. The image signals V1 to V4 are A/D-converted by the ADC 522 in accordance with various pulses generated by the TG 526 on the basis of clocks from the quartz oscillator 525. The digital signals undergo image processing by the DSPs 523 and 524.

An output from the DSP 523 is output to a microcomputer (not shown) via a signal line 510 in synchronism with VD1 and HD1. The microcomputer generates control signals for controlling the GCA 521, DSPs 523 and 524, TG 526, and OSD 529, and outputs the signals to the image processing apparatus via a control line 511.

Outputs from the DSP 524 are temporarily written in the frame memory 531 in synchronism with VD1 and HD1, read out in synchronism with VD2 and HD2, and input as the image signals V1′ to V4′ to the SW 528.

The SW 528 also receives a blue matte signal generated by the blue matte generation circuit 527, and selects and outputs either the image signal or blue matte signal. An output signal (VIDEO OUT) from the SW 528 is multiplexed with an output from the OSD 529, and the resultant signal is input to the LCD operation circuit 530.

The image signals V1, V2, and V4 are obtained by low-resolution reading and used for, e.g., AE and/or AF. The image signal V3 is obtained by high-resolution reading and used for, e.g., display on a monitor (not shown).

The image signal V3 has a large data amount and takes a long image processing time because the signal V3 is obtained by reading an image at a high resolution. While the image signal V3 is processed, the image signal V2 written in the frame memory 531 is repetitively read out and output. That is, an image signal V2′ is repetitively read out, as shown in FIG. 17.

In the prior art, a microcomputer or the like inputs an image signal every frame. The input time periods to take image signals in actual image sensing and pre-image sensing for AE/AF are different from each other. The input time periods to take the image signals of high- and low-resolution images are also different from each other.

A different input time period leads to a different image signal output level, and correction processing of adjusting the levels of image signals sensed in different input time periods must be executed. Further, the image sensing apparatus requires a frame memory which temporarily stores images signals having undergone signal processing in order to output image signals at proper timings. This interferes with reduction in size, weight, and power consumption of an image processing apparatus.

In particular, most digital cameras and bar code readers are required to be portable, and it is preferable to decrease the number of unnecessary members as much as possible in order to realize lightweight, small size, and low power consumption.

### SUMMARY OF THE INVENTION

According to the present invention, the foregoing object is attained by providing an image sensing apparatus comprising a sensor which generates an image signal of an object, an operation unit which, when signals of a plurality of frames of the object are read out from the sensor at a first resolution and a second resolution higher than the first resolution, operates the sensor so as to set intervals between read-out starts of image signals of the plurality of frames to be constant, and a controller which performs control so as to execute at least one of exposure adjustment and focus adjustment on the basis of an image signal read out from the sensor at the first resolution, and to execute image processing on the basis of an image signal read out from the sensor at the second resolution under an adjusted condition.

According to the present invention, the foregoing object is also attained by providing an image sensing apparatus comprising a sensor which generates an image signal of an object, an operation unit which, when signals of a plurality of frames of the object are read out from the sensor at a first resolution and a second resolution higher than the first resolution, operates the sensor so as to set intervals between read-out starts of image signals of the plurality of frames to be constant, and a controller which performs control so as to authenticate the object on the basis of an image signal read out from the sensor at the second resolution when the object cannot be authenticated based on an image signal read out from the sensor at the first resolution.

According to the present invention, the foregoing object is also attained by providing an image sensing method of generating an image signal of an object by a sensor and processing the obtained image signal comprising the steps of when signals of a plurality of frames of the object are read out from the sensor at a first resolution and a second resolution higher than the first resolution, operating the sensor so as to set intervals between read-out starts of image signals of the plurality of frames to be constant, and executing at least one of exposure adjustment and focus adjustment on the basis of an image signal read out from the sensor at the first resolution, and executing image processing on the basis of an image signal read out from the sensor at the second resolution under an adjusted condition.

According to the present invention, the foregoing object is also attained by providing an image sensing method of generating an image signal of an object by a sensor and processing the obtained image signal comprising the steps of when signals of a plurality of frames of the object are read out from the sensor at a first resolution and a second resolution higher than the first resolution, operating the sensor so as to set intervals between read-out starts of image signals of the plurality of frames to be constant, authenticating the object on the basis of an image signal read out from the sensor at the first resolution, and authenticating the object on the basis of an image signal read out from the sensor at the second resolution when the object cannot be authenticated based on an image signal read out from the sensor at the first resolution.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic arrangement of a handy type bar code reader according to the first embodiment of the present invention;

FIG. 2 is a block diagram showing the internal arrangement of an image processor in FIG. 1;

FIG. 3 is a block diagram showing the arrangement of a sensor in FIG. 2;

FIG. 4 is a circuit diagram showing the arrangement of a pixel portion in FIG. 3;

FIG. 5 is a block diagram showing the internal arrangement of a TG in FIG. 2;

FIG. 6 is a flow chart showing the operation of the bar code reader shown in FIG. 1;

FIGS. 7A to 7E are views showing image examples displayed on a monitor in image sensing by the bar code reader shown in FIG. 1;

FIG. 8 is a timing chart showing the operation of the image processor;

FIG. 9 is a flow chart showing the operation of step S11 shown in FIG. 6;

FIGS. 10A and 10B are timing charts showing vertical reading control signals and output signals in high- and low-resolution reading operations;

FIGS. 11A and 11B are timing charts showing horizontal reading control signals and output signals in high- and low-resolution reading operations;

FIG. 12 is a block diagram showing the internal arrangement of a microcomputer in FIG. 1;

FIGS. 13A to 13C are views for schematically explaining a fingerprint authentication apparatus according to the second embodiment of the present invention;

FIG. 14 is a block diagram showing the schematic arrangement of the fingerprint authentication apparatus according to the second embodiment of the present invention;

FIG. 15 is a flow chart showing the operation of the fingerprint authentication apparatus in FIG. 14;

FIG. 16 is a block diagram showing the schematic arrangement of a conventional image processing apparatus; and

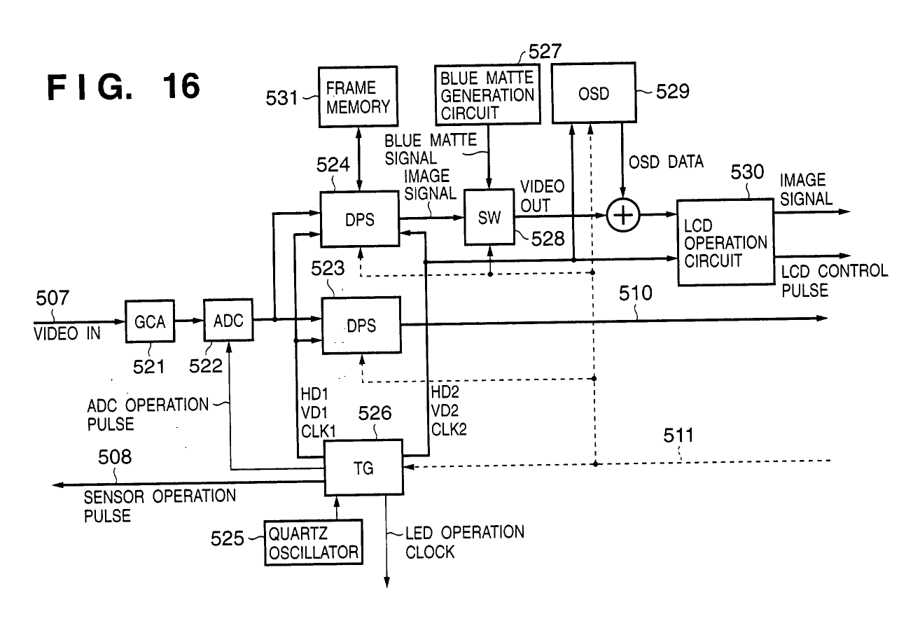

FIG. 17 is a timing chart showing the operation of the image processing apparatus shown in FIG. 16.

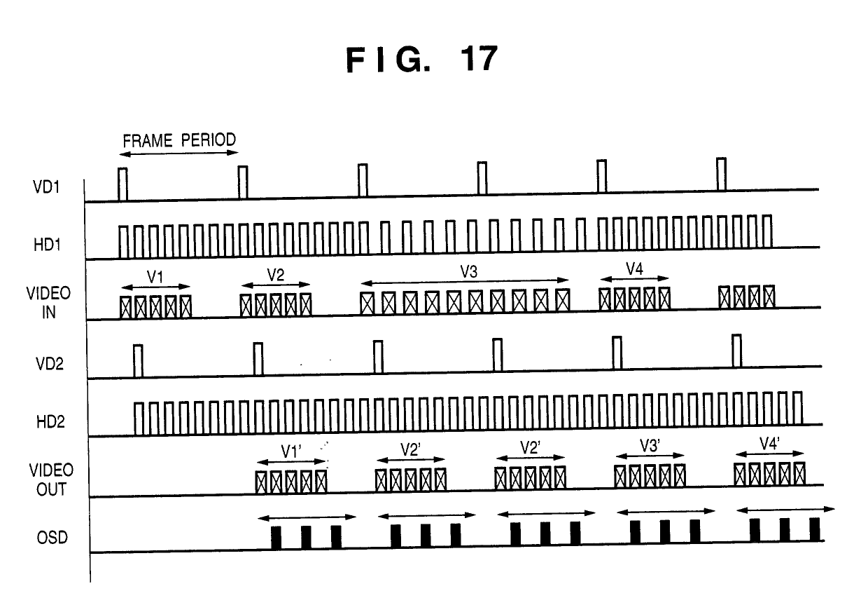

### DETAILED DESCRIPTION OF THE PREFERRED EMBODIMENTS

Preferred embodiments of the present invention will be described in detail in accordance with the accompanying drawings.

### First Embodiment

### General Description

The first embodiment of the present invention will exemplify a bar code reader. The bar code reader of the first embodiment reads a bar code at a high resolution and converts it into character data. Prior to this operation, the bar code reader reads a bar code at a low resolution and adjusts the light quantity of a light source and the gain used for image processing.

In the first embodiment of the present invention, an image is always read out at the longest time interval taken to read a bar code regardless of switching of the resolution between low-resolution reading for adjusting the light quantity and gain and high-resolution reading for obtaining character data.

### Description of Arrangement

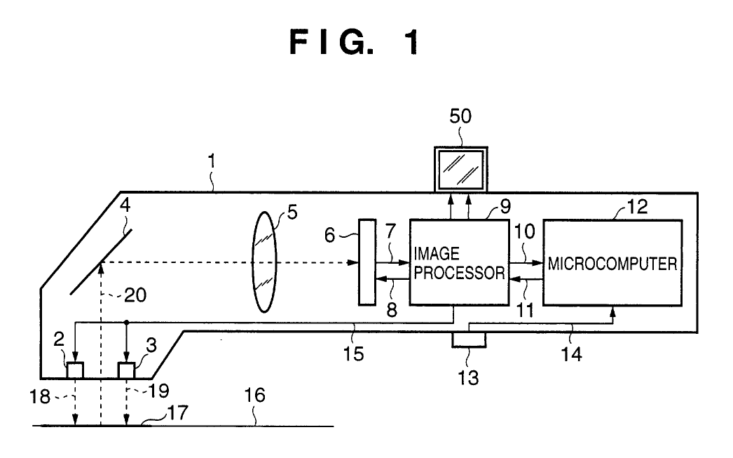

FIG. 1 is a block diagram showing the schematic arrangement of a handy type bar code reader according to the first embodiment of the present invention.

In FIG. 1, reference numeral 1 denotes a bar code reader main body; 2 and 3, LEDs serving as illumination light sources; 4, a mirror which changes the travelling direction of a reflected beam 20 of irradiation beams 18 and 19 emitted by the LEDs 2 and 3; 5 a lens which converges the reflected beam 20 whose course is changed by the mirror 4; 6, a sensor having an image sensing element of, e.g., CMOS type or CCD type; 7, a signal line which transmits an image signal from the sensor 6; 8, a control line for operating the sensor 6; 9, an image processor which processes an image signal from the sensor 6; 10, a signal line which transmits an image signal from the image processor 9; 11, a control line for controlling the image processor 9; 12, a microcomputer which controls the operation of the bar code reader main body 1; 13, an operation switch; 14, a signal line extending from the operation switch 13 to the microcomputer 12; 15, a control line for controlling the irradiation light quantities of the LEDs 2 and 3; 16, a printed matter which bears a bar code; 17, a bar code printed on the printed matter 16; 18 and 19, the irradiation beams emitted by the LEDs 2 and 3; 20, the beam reflected by a bar code; and 50, a monitor such as a liquid crystal display (LCD) which displays an image processed by the image processor 9.

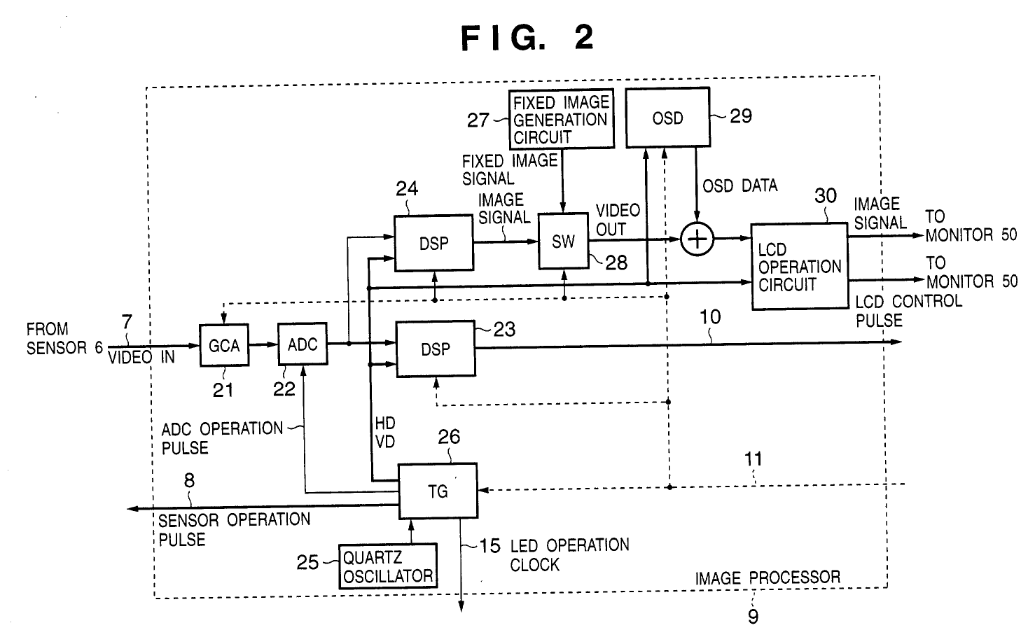

FIG. 2 is a block diagram showing the internal arrangement of the image processor 9 in FIG. 1. In FIG. 2, reference numeral 21 denotes a gain control amplifier (GCA) which adjusts the gain of an image signal input via the signal line 7; 22, an analog digital converter (ADC) which converts an output from the GCA 21 from an analog signal to a digital signal; 23 and 24, digital signal processors (DSP) which perform digital image processing for the contrast or γ conversion of an output from the ADC 22; 27, a fixed image generation circuit which generates a signal of a fixed image such as a uniform color image or predetermined pattern image to be displayed on the monitor 50; 28, a switch (SW) which selects either one of an image signal from the DSP 24 and a fixed image signal from the fixed image generation circuit 27; 29, an on-screen display (OSD) for multi-displaying images (OSD DATA) representing the processing state of the bar code reader main body 1; 30, an LCD operation circuit for transmitting an image signal and control pulse to the monitor 50; 25, a quartz oscillator which generates a clock; and 26, a timing generator (TG) which generates various operation pulses to the sensor 6, ADC 22, DSPs 23 and 24, LCD operation circuit 30, and the like on the basis of clocks from the quartz oscillator 25.

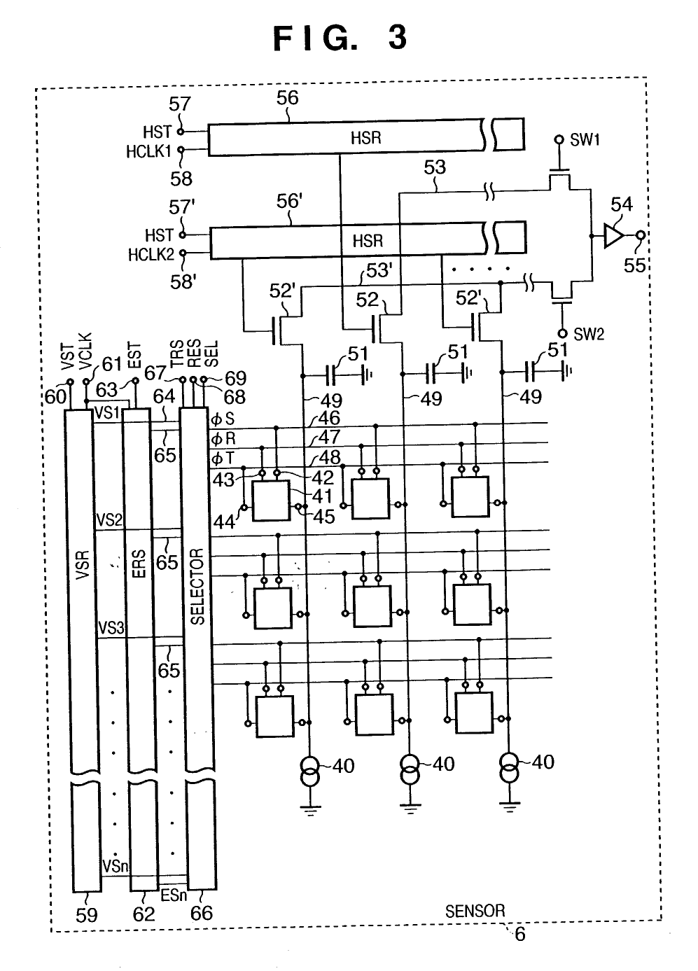

FIG. 3 is a block diagram showing an arrangement of the sensor 6 in FIG. 2, and illustrates a CMOS type sensor 6. As described above, the sensor 6 may use a known type photoelectric conversion element, instead of the CMOS sensor. The present invention is not limited by the type of sensor 6. FIG. 3 shows only nine pixels, but the sensor 6 is actually formed from a larger number of pixels.

In FIG. 3, reference numeral 41 denotes each pixel portion which constitutes one pixel of the sensor; 42, an input terminal for a reading pulse (φS) at the pixel portion 41; 43, an input terminal of a reset pulse (φR) at the pixel portion 41; 44, an input terminal of a transfer pulse (φT) at the pixel portion 41; 45, a signal reading terminal (P0) at the pixel portion 41; 46, a signal line which transmits the reading pulse (φS) from a selector 66 (to be described later) to respective pixels arranged in the horizontal direction; 47, a signal line which transmits the reset pulse (φR) from the selector 66 (to be described later) to respective pixels arranged in the horizontal direction; 48, a signal line which transmits the transfer pulse (φT) from the selector 66 (to be described later) to respective pixels arranged in the horizontal direction; 49, a vertical signal line; 40, a constant current source; 51, a capacitor connected to the vertical signal line 49; 52, a transfer switch having a gate connected to a horizontal shift register 56 and a source and drain connected to the vertical signal line 49 and an output signal line 53; 52′, a transfer switch having a gate connected to a horizontal shift register 56′ and a source and drain connected to the vertical signal line 49 and output signal line 53; 54, an output amplifier connected to output signal lines 53 and 53′; and 55, an output terminal of the sensor 6.

Reference numerals 56 and 56′ denote horizontal shift registers (HSR); 57 and 57′, input terminals of start pulses (HST) for the HSRs 56 and 56′; and 58 and 58′, input terminals of transfer clocks (HCLK1 and HCLK2) for the HSRs 56 and 56′.

Reference numeral 59 denotes a vertical shift register (VSR); 60, an input terminal of a start pulse (VST) for the VSR 59; 61, an input terminal of a transfer pulse (VCLK) for the VSR 59; 62, an electronic shutter shift register (ESR) of a type called a rolling shutter (to be described later); 63, an input terminal of a start pulse (EST) for the ESR 62; 64, an output line of the vertical shift register (VSR); 65, an output line of the electronic shutter shift register (ESR); 66, a selector; 67, an input terminal of a seed signal TRS of a transfer pulse; 68, an input terminal of a seed signal RES of a reset pulse; and 69, an input terminal of a seed signal SEL of a reading pulse.

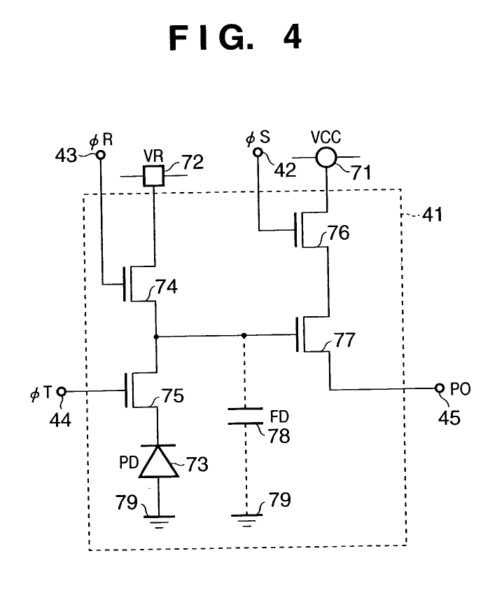

FIG. 4 is a circuit diagram showing an arrangement of the pixel portion 41 in FIG. 3. In FIG. 4, reference numeral 71 denotes a power supply voltage (VCC); 72, a reset voltage (VR); 73, a photodiode; 74 to 77, switches formed from MOS transistors; 78, a Floating Diffusion portion (FD) which expresses a parasitic capacitance; and 79, ground.

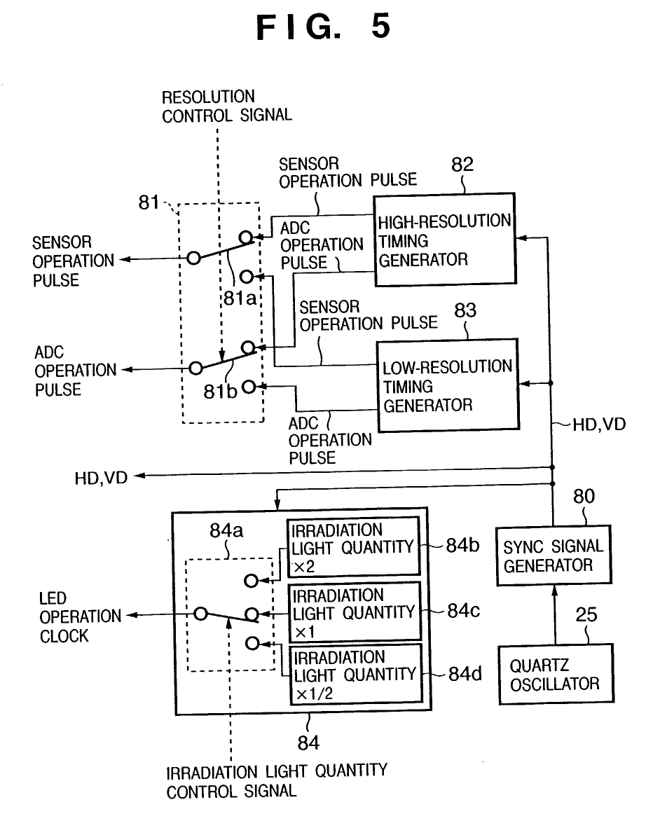

FIG. 5 is a block diagram showing the internal arrangement of the TG 26 in FIG. 2. In FIG. 5, reference numeral 80 denotes a sync signal generator which generates a sync signal in accordance with an output from the quartz oscillator 25; 82 and 83, high- and low-resolution timing generators, respectively, which generate sensor operation pulses and ADC operation pulses for high and low resolutions in accordance with outputs from the sync signal generator 80; 81, a switch group having switches 81a and 81b for selecting either one of outputs from the high- and low-resolution timing generators 82 and 83; and 84, an LED operation timing generator having a signal source 84b for an irradiation light quantity×1 (single), a signal source 84c for an irradiation light quantity×2 (double), a signal source 84d for an irradiation light quantity×½ (one half), and a switch 84a for selecting any one of outputs from the signal sources 84b to 84d.

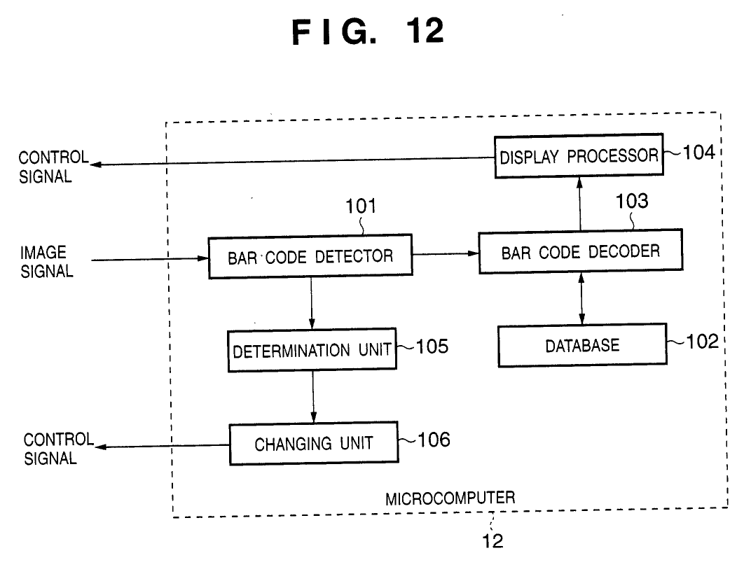

FIG. 12 is a block diagram showing the internal arrangement of the microcomputer 12 in FIG. 1. In FIG. 12, reference numeral 101 denotes a bar code detector which detects the position of the bar code 17 from the image signals of the bar code 17 and printed matter 16; 105, a determination unit which determines whether the image brightness and/or contrast of the bar code 17 detected by the bar code detector 101 is enough to decode the image of the bar code 17; 106, a changing unit which transmits a control signal which prompts the image processor 9 to change image sensing conditions on the basis of the determination result of the determination unit 105; 103, a bar code decoder which identifies the type, kind, and character of the bar code 17 detected by the bar code detector 101 on the basis of various pieces of information stored in a database 102 and converts the bar code image into a character code; and 104, a display processor for displaying on the monitor 50 a processing state based on an output from the bar code decoder 103 and the determination result of the determination unit 105.

### Description of Operation

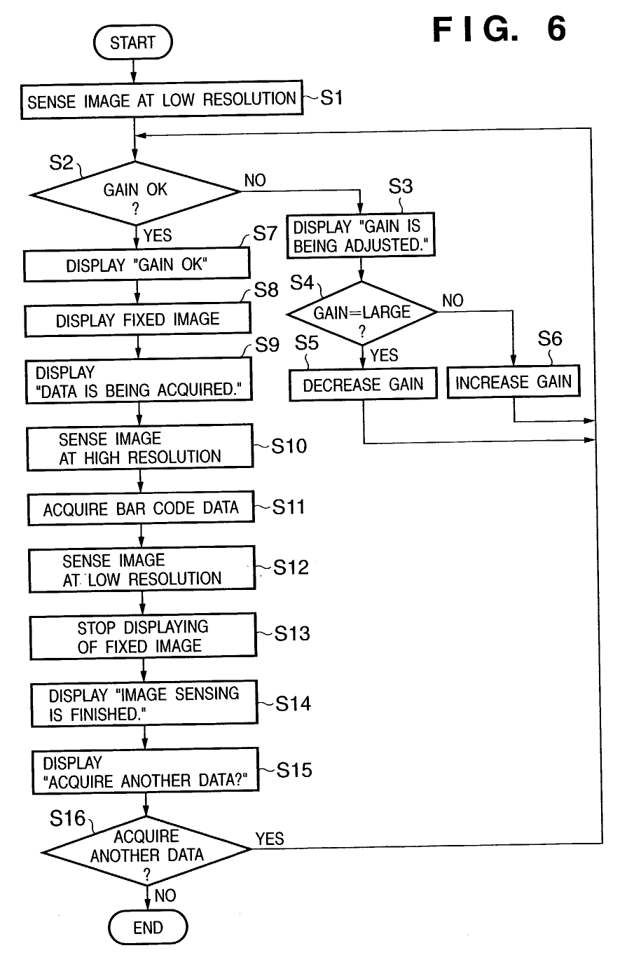

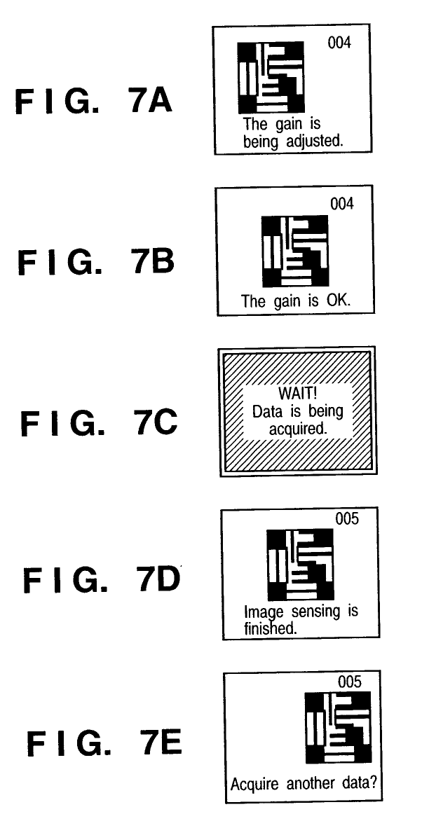

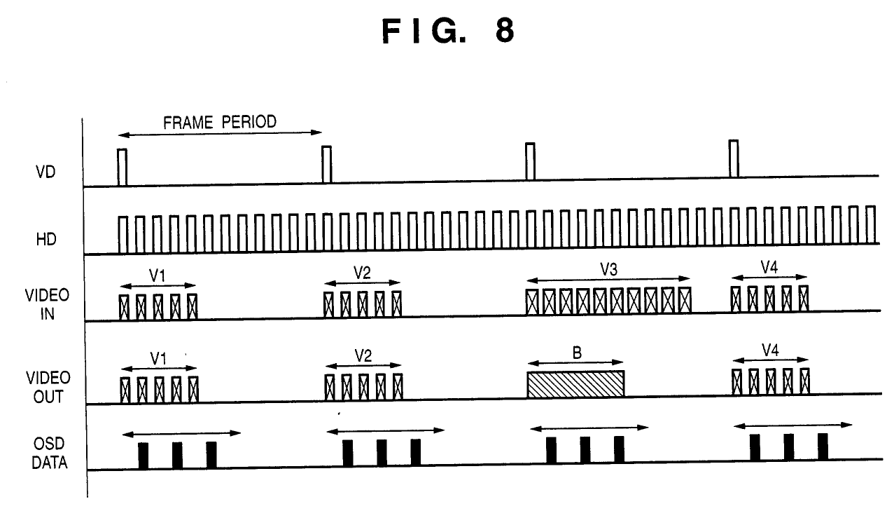

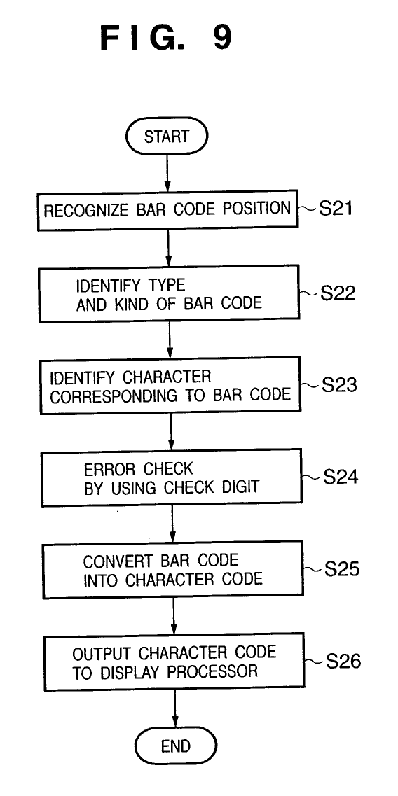

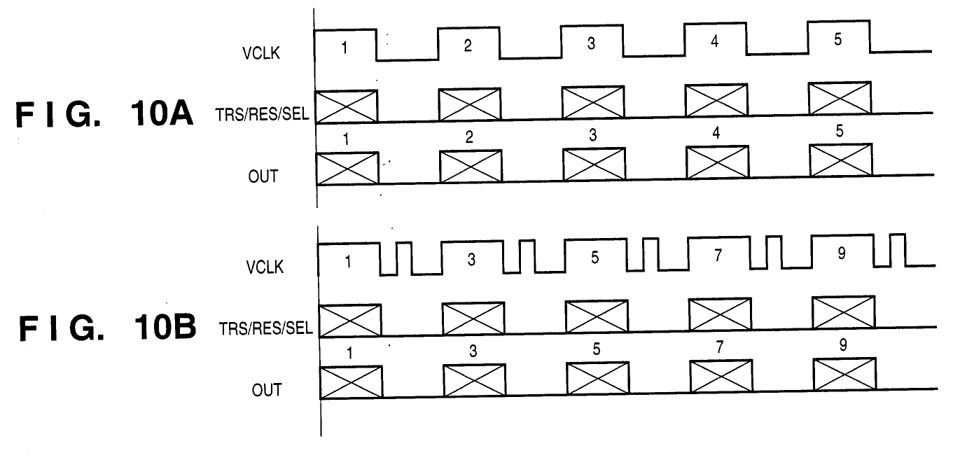

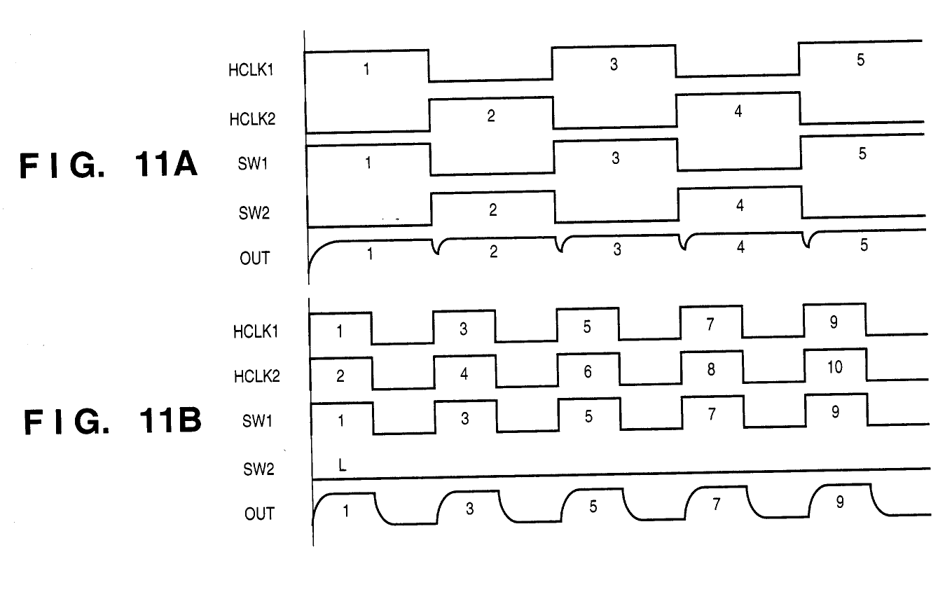

FIG. 6 is a flow chart showing the operation of the bar code reader shown in FIG. 1. FIGS. 7A to 7E are views showing image examples displayed on the monitor 50 in actual image sensing of the bar code reader main body 1 shown in FIG. 1. FIG. 8 is a timing chart showing the operation of the image processor 9. FIG. 9 is a flow chart showing the operation of step S11 shown in FIG. 6. FIGS. 10A and 10B are timing charts showing vertical reading control signals and output signals in high- and low-resolution reading operations. FIGS. 11A and 11B are timing charts showing horizontal reading control signals and output signals in high- and low-resolution reading operations. Note that figures in FIGS. 10A and 10B represent rows subjected to reading, and figures in FIGS. 11A and 11B represent columns subjected to reading.

The operation of the bar code reader 1 having the arrangements shown in FIGS. 1 to 5 and 12 will be explained with reference to FIGS. 6 to 11B. The bar code 17 on the printed matter 16 is sensed at a low resolution (step S1).

More specifically, the image processor 9 issues a light-emitting instruction via the control line 15. Then, the LEDs 2 and 3 emit light, and their irradiation beams 18 and 19 irradiate the printed matter 16. The optical path of the beam 20 reflected by the printed matter 16 is changed by the mirror 4 toward the lens 5. The beam 20 is converged by the lens 5 and forms an image on the sensor 6.

At this time, charges corresponding to the incident beam are accumulated in the photodiode 73 while the reset switch 74 and a switch 75 connected to the photodiode 73 are open.

While a switch 76 is open, the switch 74 is closed to reset the parasitic capacitance 78. Then, the switch 74 is opened, and the switch 76 is closed to read out charges in the reset state to the signal reading terminal 45.

While the switch 76 is open, the switch 75 is closed to transfer the charges accumulated in the photodiode 73 to the parasitic capacitance 78. While the switch 75 is open, the switch 76 is closed to read out the signal charges to the signal reading terminal 45.

The operation pulses φS, φR, and φT of the MOS transistors are generated by the vertical shift registers 59 and 62 and the selector 66 (to be described later). The operation pulses φS, φR, and φT are sequentially supplied via the signal lines 46 to 48 to the input terminals 42 to 44 of pixels on odd rows for a low resolution (FIG. 10B) and to the input terminals 42 to 44 of pixels on all the rows for a high resolution (FIG. 10A).

An input signal for the vertical shift register 59 and selector 66 and vertical signal reading operation at low and high resolutions will be explained.

For a high resolution, as shown in FIG. 10A, the signals TRS, RES, and SEL are input as one pulse each to the input terminals 67 to 69 in response to one pulse of a clock signal VCLK input from the input terminal 61. The operation pulses φS, φR, and φT are output in synchronism with the signals TRS, RES, and SEL. As a result, the operation pulses φS, φR, and φT are supplied to the input terminals 42 to 44 of pixels on all the rows.

For a low resolution, as shown in FIG. 10B, the signals TRS, RES, and SEL are input as one pulse each to the input terminals 67 to 69 in response to two pulses of the clock signal VCLK input from the input terminal 61. The operation pulses φS, φR, and φT are output in synchronism with the signals TRS, RES, and SEL. Thus, the operation pulses φS, φR, and φT are supplied to the input terminals 42 to 44 of pixels on every other row (odd or even rows).

An input signal for the horizontal shift registers 56 and 56′ and horizontal signal reading operation at low and high resolutions will be described.

For a high resolution, as shown in FIG. 11A, the “high/low” of signals supplied to switches SW1 and SW2 are switched in synchronism with clock signals alternately input from the input terminals 58 and 58′.

The signal reading terminal 45 is connected via the vertical signal line 49 to the constant current source 40 and to the vertical signal line capacitor 51 and transfer switches 52 and 52′. A charge signal is transferred to the vertical signal line capacitor 51 via the vertical signal line 49. After that, the transfer switches 52 and 52′ are sequentially closed in accordance with outputs from the horizontal shift registers 56 and 56′. The signal on the vertical signal line capacitor 51 is read out to the output signal line 53 or 53′, and output from the output terminal 55 via the SW1 or SW2 which alternately opens, as described above, and further via the output amplifier 54. In this manner, electrical signals are successively output to the output amplifier 54. As a result, the electrical signals of pixels on all the columns are read out.

The reading order of the pixel portions 41 in high-resolution reading is as follows. The first upper row in the vertical direction is selected, and pixel portions 41 of the respective columns are sequentially selected to output signals from left to right along with scanning of the horizontal shift registers 56 and 56′. After signals are completely output from the first row, the second row is selected, and pixel portions 41 of the respective columns are sequentially selected to output signals from left to right along with scanning of the horizontal shift registers 56 and 56′.

Similarly, rows are vertically scanned from the third row, fourth row, . . . in accordance with sequential scanning of the vertical shift register 59, outputting an image of one frame.

For a low resolution, only the switch SW1 is alternately opened and closed in synchronism with clock signals input from the input terminals 58 and 58′ at the same timing. Only the electrical signals of pixels on every other column (even columns in the arrangement shown in FIG. 3) are intermittently output to the output amplifier 54. Consequently, the electrical signals of pixels on even columns, in the arrangement shown in FIG. 3, are read out.

As described above, the vertical shift register (VSR) 59 starts scanning upon reception of a start pulse (VST) input from the input terminal 60, and sequentially transfers and outputs VS1, VS2, . . . , VSn via the output line 64 every pulse of a transfer clock (VCLK) input from the input terminal 61. The electronic shutter vertical shift register (ESR) 62 starts scanning upon reception of a start pulse (EST) input from the input terminal 63, and sequentially transfers and outputs signals to the output line 65 every pulse of a transfer clock (VCLK) input from the input terminal 61.

In general, a CMOS sensor does not have any light-shielded buffer memory such as a vertical transfer CCD, unlike an interline transfer (IT) or frame-interline transfer (FIT) CCD element. While signals obtained from pixel portions 41 are sequentially read out, pixel portions 41 which have not output any signals are kept exposed. For this reason, the accumulation time changes depending on the pixel position even within one frame. For example, if signals are sequentially read out after resetting all the pixels at once, outputs between the first read pixel and the final read pixel differ by about the reading time of one frame, i.e., the final pixel portion 41 is exposed by this extra time.

To avoid this phenomenon, the CMOS sensor adopts, as an electronic shutter (focal plain shutter), a rolling shutter operation method of parallel-performing vertical scanning for the start and end of exposure so as to make the exposure amount equal on all the vertical rows. The image of the read bar code 17 is sent to the image processor 9 via the signal line 7.

In the image processor 9, the gain of an image signal (VIDEO IN) from the sensor 6 is adjusted by the GCA 21 in accordance with a gain control signal fed back from the microcomputer 12 via the control line 11, as needed.

An output from the GCA 21 is A/D-converted by the ADC 22 in accordance with an ADC operation pulse generated by the TG 26 on the basis of a clock from the quartz oscillator 25. The digital signal undergoes image processing in the DSPs 23 and 24. An output (VIDEO OUT) from the DSP 23 is output to the microcomputer 12 via the signal line 10.

As will be described in detail later, the microcomputer 12 performs exposure adjustment and focus adjustment on the basis of a low-resolution image signal from the sensor 6.

The microcomputer 12 receives an image signal from the image processor 9, and the bar code detector 101 recognizes the position of the bar code 17 on the printed matter 16. Based on the detection result of the bar code detector 101, the determination unit 105 checks whether the image brightness and/or contrast of the bar code 17 is enough to decode the image of the bar code 17 (step S2).

If YES in step S2, the flow shifts to step S7; if NO, to step S3.

In step S3, the display processor 104 outputs a control signal to the SW 28 and OSD 29 in accordance with an output from the determination unit 105 in order to display, e.g., “the gain is being adjusted.” on the monitor 50. Accordingly, an image as shown in FIG. 7A is displayed on the monitor 50 via the LCD operation circuit 30.

Instead of gain adjustment, an image enough to decode it may be obtained by changing the illumination intensities of the LEDs 2 and 3. When the illumination intensities of the LEDs 2 and 3 are to be changed, an LED operation clock for adjusting the illumination intensity is sent from the TG 26 of the image processor 9 to the LEDs 2 and 3 via the control line 15, adjusting the irradiation light quantity.

The determination unit 105 checks whether the gain of the image signal is larger than a gain necessary to decode the image of the bar code 17 (step S4).

If YES in step S4, the determination unit 105 instructs the changing unit 106 to send such a control signal as to decrease the gain stepwise to the GCA 21. In turn, the changing unit 106 outputs a corresponding control signal to the GCA 21, and the flow returns to step S2 (step S5).

If NO in step S4, the determination unit 105 instructs the changing unit 106 to send such a control signal as to increase the gain stepwise to the GCA 21. In turn, the changing unit 106 outputs a corresponding control signal to the GCA 21, and the flow returns to step S2 (step S6).

After gain adjustment is completed (i.e., YES in step S2), the flow shifts to step S7.

In step S7, the display processor 104 outputs a control signal to the SW 28 and OSD 29 in accordance with an output from the determination unit 105 in order to display, e.g., “the gain is OK.” as shown in FIG. 7B on the monitor 50. Accordingly, an image as shown in FIG. 7B is displayed on the monitor 50 via the LCD operation circuit 30.

An image signal reading timing and the like will be described with reference to FIG. 8. In FIG. 8, HD and VD represent horizontal and vertical sync signals for inputting an image signal from the sensor 6; VIDEO IN, an image signal input to the image processing apparatus; VIDEO OUT, an image signal output from the image processing apparatus; and OSD DATA, a character signal generated by the OSD 29.

VD and HD are output from the TG 26 in synchronism with a reading time (to be referred to as a “frame reading period” hereinafter) during which the reading time of the image signal of a frame image from the sensor 6 is maximized. In this case, VD and HD are output in synchronism with the reading time of the image signal V3. More specifically, a time taken to read an image at the highest resolution of the sensor 6 is set in advance as a fixed frame reading time, and one image is read every frame reading time regardless of the resolution.

The image signals V1, V2, and V4 are obtained by low-resolution reading, and the image signal V3 is obtained by high-resolution reading. The read image signals V1 to V4 are read out at the same timing as reading of the image signals V1 to V4 regardless of the resolution (VIDEO OUT). In reading out the image signals V1 to V4, character signals generated by the OSD 29 are superposed on the image signals V1 to V4.

For example, a character signal generated by the OSD 29 is superposed on the image signal V1 to display an image shown in FIG. 7A on the monitor 50. A character signal is superposed on the image signal V2 to display an image shown in FIG. 7B on the monitor 50. The image signal V3 is not sent to the monitor 50, but a character signal is superposed on a fixed image signal to display an image shown in FIG. 7C on the monitor 50. A character signal is superposed on the image signal V4 to display an image shown in FIG. 7D on the monitor 50.

That is, the image signals V1, V2, and V4 are output to the monitor 50 before/after switching the resolution. In switching the resolution, a fixed image signal is output to the monitor 50 in place of the image signal V3.

In other words, the SW 28 receives an output from the DSP 24 and a fixed image signal generated by the fixed image generation circuit 27, and selects either one of them. In this case, as shown in FIG. 7C, the monitor 50 is switched to display of a fixed image, and displays “WAIT! Data is being acquired.” (steps S8 and S9).

The image processor 9 applies an operation pulse to the sensor 6 via the control line 8, and actual image sensing is executed under the following new image sensing conditions (step S10).

In step S10, the resolution is switched from a low resolution to a high resolution, and the image of the bar code 17 is input to the bar code reader main body 1 (step S11).

The input image is sent to the microcomputer 12 by the same procedure as step S1. In the microcomputer 12, the image of the read bar code 17 is decoded by the bar code decoder 103 on the basis of various pieces of information stored in the database 102.

More specifically, the bar code detector 101 recognizes the position of the bar code 17 (step S21 in FIG. 9).

The bar code decoder 103 recognizes the type and kind of bar code 17 (step S22).

Then, the bar code decoder 103 identifies the character corresponding to the bar code 17 by comparing coded data with data stored in the memory (step S23).

Then, the bar code decoder 103 uses a check digit to check whether an identification error or the like has occurred (step S24).

If no error has occurred, the bar code decoder 103 converts the character of the bar code 17 into a character code such as an ASCII code (step S25).

Finally, the bar code decoder 103 outputs the converted data to the display processor 104 in order to display the data on the monitor 50 or the like (step S26).

The flow returns to the processing in FIG. 6, and the bar code decoder 103 notifies the determination unit 105 that the image of the bar code 17 has been converted into character data. Based on this notification, the determination unit 105 sends to the image processor 9 a control signal which switches back the resolution from a high resolution to a low resolution (step S12).

The display processor 104 cancels display of the fixed image upon reception of data from the bar code decoder 103 (step S13).

The display processor 104 displays the completion of actual image sensing, as shown in FIG. 7D (step S14).

Then, as shown in FIG. 7E, the display processor 104 displays an instruction which prompts the user to select whether to read another bar code (step S15).

If YES in step S16, the flow returns to step S2; if NO, the processing shown in FIG. 6 ends (step S16).

### Second Embodiment

### General Description

The second embodiment of the present invention will exemplify a fingerprint authentication apparatus. The fingerprint authentication apparatus of the second embodiment reads a fingerprint at a low resolution, compares it with a pre-registered fingerprint, and determines whether these fingerprints coincide with each other. If authentication is difficult to perform by a fingerprint image read at a low resolution, the resolution is switched to a higher one, and a fingerprint is read again.

At this time, an image is always read out at the longest reading time interval regardless of the resolution used for reading. More specifically, a time taken to read an image at the highest resolution of the sensor is set in advance as a fixed frame reading time, and one image is read every frame reading time regardless of the resolution.

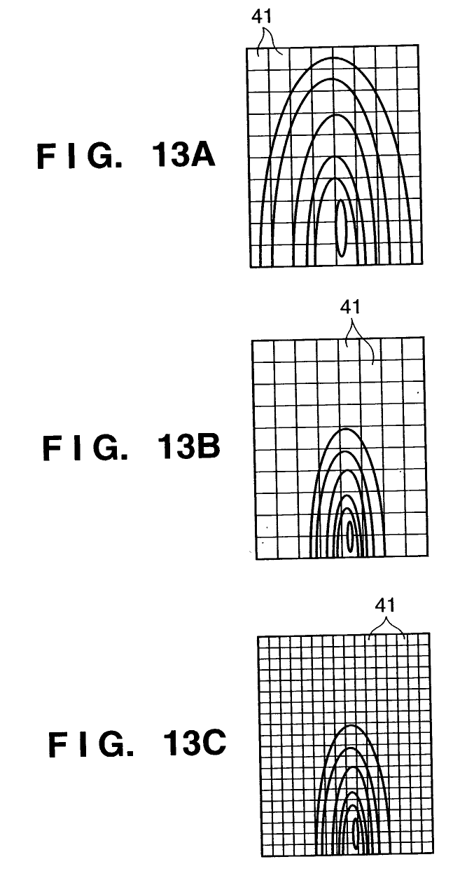

FIGS. 13A to 13C are views for explaining the schematic operation of the fingerprint authentication apparatus according to the second embodiment of the present invention. FIG. 13A shows a schematic state in which the finger of an adult is sensed at a low resolution. FIG. 13B shows a schematic state in which the finger of a child is sensed at a low resolution. FIG. 13C shows a schematic state in which the finger of the child is sensed at a high resolution.

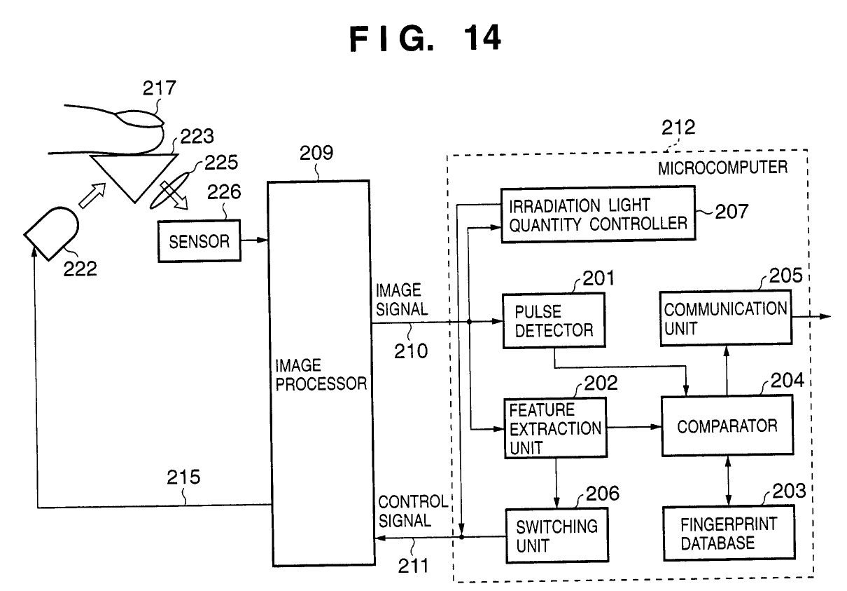

Rectangles in FIGS. 13A to 13C represent pixel portions of a sensor 226 shown in FIG. 14.

As described above, in the second embodiment a fingerprint is sensed at a low resolution first. If the fingerprint belongs to an adult, as shown in FIG. 13A, characteristic portions such as the ridges of the fingerprint necessary to authenticate spread over pixels, and the fingerprint can be authenticated.

If, however, the fingerprint belongs to a child, as shown in FIG. 13B, a plurality of characteristic portions such as the ridges of the fingerprint necessary to authenticate do not spread over pixels but fall within small pixel region, and the fingerprint may not be authenticated.

In the second embodiment, therefore, if a fingerprint sensed at a low resolution cannot be authenticated, the resolution is switched to a higher one, and the fingerprint is sensed again and authenticated.

### Description of Arrangement

FIG. 14 is a block diagram showing the schematic arrangement of the fingerprint authentication apparatus according to the second embodiment of the present invention. In FIG. 14, reference numeral 222 denotes an LED serving as an illumination light source; 223, a pad which is made of a transparent material and used to set a finger 217 serving as an object to be sensed; and 225, a lens which converges light reflected by the finger 217. The sensor 226 comprises an image sensing element of, e.g., a CMOS or CCD type, and has the same arrangement as that of the first embodiment. Operation control at high and low resolutions are performed similarly to the first embodiment.

Reference numeral 209 denotes an image processor which processes an image signal from the sensor 226; 210, a signal line which transmits an image signal from the image processor 209; 211, a control line for controlling the image processor 209; and 212, a microcomputer which controls the operation of the fingerprint authentication apparatus.

In the microcomputer 212, reference numeral 201 denotes a pulse detector which detects based on the presence/absence of a change of an image signal caused by a pulse whether an object to be authenticated is a human fingerprint; 202, a feature extraction unit which extracts a feature such as the ridge end of a fingerprint from an image signal; 204, a comparator which is triggered when the pulse detector 201 detects that an image signal represents a human fingerprint, and which compares the position of a feature extracted by the feature extraction unit 202 with a fingerprint registered in advance in a fingerprint database 203; 205, a communication unit which sends the comparison result of the comparator 204 to a host computer or the like via a network such as the Internet or LAN; 206, a switching unit which switches the resolution from a low resolution to a high resolution when the feature extraction unit 202 cannot satisfactorily extract a feature; and 207, an irradiation light quantity controller which controls the exposure amount of the LED 222 based on an image signal.

### Description of Operation

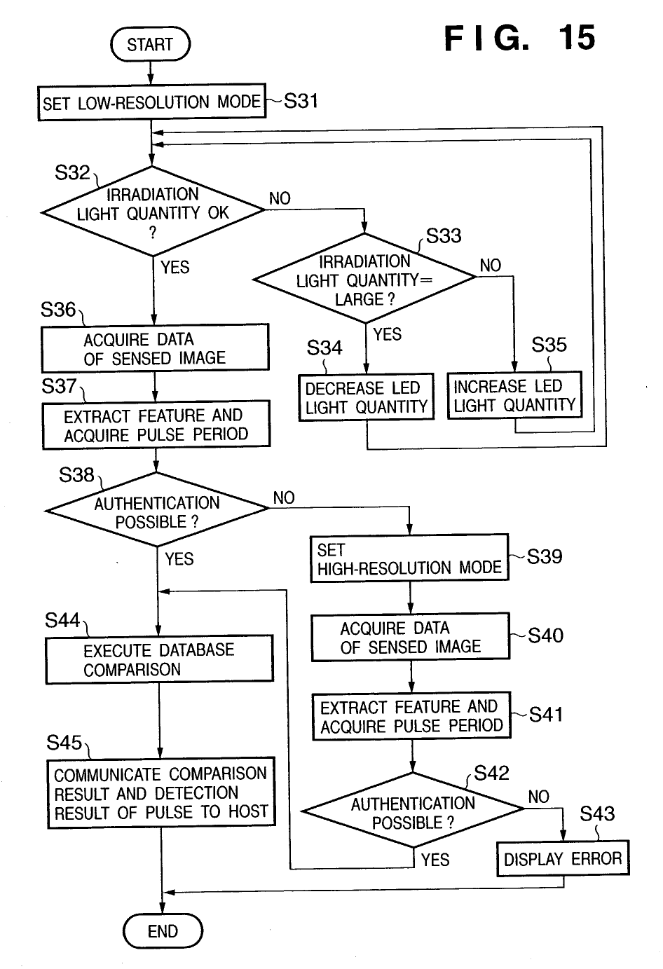

FIG. 15 is a flow chart showing the operation of the fingerprint authentication apparatus in FIG. 14. The flow chart shown in FIG. 15 assumes that the fingerprint authentication apparatus is mounted in, e.g., a portable telephone, electronic commerce is performed via the Internet using the portable telephone, and personal identification is authenticated using the fingerprint authentication apparatus in payment.

A low-resolution mode is set prior to image sensing of the finger 217 (step S31).

If the image processor 209 issues a light-emitting instruction via a control line 215, the LED 222 emits light, and the illumination light irradiates the finger 217. The light reflected by the finger 217 forms an image on the sensor 226.

The sensor 226 converts the reflected light into an electrical signal and sends the electrical signal as an image signal to the image processor 209 via a signal line. The image processor 209 processes the received image signal and outputs the processed signal to the microcomputer 212.

In the microcomputer 212, the irradiation light quantity controller 207 checks based on the input signal whether the irradiation light quantity of the LED 222 is proper (step S32).

If it is determined in step S32 that the luminance and contrast of the image of the finger 217 are enough to sense a fingerprint, the flow shifts to step S36; if NO, to step S33.

In step S33, the irradiation light quantity controller 207 checks whether the irradiation light quantity of the LED 222 is larger than an irradiation light quantity necessary to decode the image of the finger 217.

If YES in step S33, the irradiation light quantity controller 207 sends such a control signal as to decrease the light quantity of the LED 222 stepwise to the image processor 209. The image processor 209 decreases the irradiation light quantity in accordance with this signal (step S34).

If NO in step S33, the irradiation light quantity controller 207 sends such a control signal as to increase the light quantity of the LED 222 stepwise to the image processor 209. The image processor 209 increases the irradiation light quantity in accordance with this signal (step S35).

Instead of adjusting the irradiation light quantity of the LED 222, the gain may be adjusted, similar to the first embodiment.

After adjustment of the irradiation light quantity is completed, the flow shifts to step S36, and the finger 217 is sensed under predetermined image sensing conditions.

The obtained image is transmitted to the microcomputer 212 by the same procedure as in step S31. The microcomputer 212 outputs the read image of the finger 217 to the pulse detector 201 and feature extraction unit 202 in parallel.

The pulse detector 201 detects on the basis of the presence/absence of a change of the image signal caused by a pulse whether an object to be authenticated is a human fingerprint, and outputs the detection result to the comparator 204. The feature extraction unit 202 extracts a feature such as the ridge end of the fingerprint from the image signal, and outputs the feature to the comparator 204 (step S37).

The comparator 204 checks whether the number of features necessary to authenticate the fingerprint have been extracted by the feature extraction unit 202 (step S38).

If NO in step S38, the flow shifts to step S39; if YES, to step S44.

In step S39, the resolution is switched from a low resolution to a high resolution.

The finger 217 is sensed again, and the image signal is sent to the microcomputer 212 (step S40).

In the microcomputer 212, the pulse detector 201 detects on the basis of the presence/absence of a change of the image signal caused by a pulse whether an object to be authenticated is a human fingerprint, and outputs the detection result to the comparator 204. The feature extraction unit 202 extracts a feature such as the ridge end of the fingerprint from the image signal, and outputs the feature to the comparator 204 (step S41).

The comparator 204 checks again whether the number of features necessary to authenticate the fingerprint have been extracted by the feature extraction unit 202 (step S42).

If NO in step S42, the flow shifts to step S43; if YES, to step S44.

In step S43, an authentication failure is informed by error display or the like, and the processing shown in FIG. 15 ends.

In step S44, the fingerprint is authenticated by looking up the fingerprint database 203 on the basis of, e.g., the positional relationship between features extracted by the feature extraction unit 202.

The authentication result is transmitted to a host computer on the seller side via the communication unit 205 together with the detection result of the pulse detector 201 (step S45).

In step S44, a fingerprint is authenticated regardless of the contents of the detection result of the pulse detector 201. Alternatively, authentication may be done when a change of an image signal due to a pulse is detected and an object to be authenticated is a human fingerprint.

The host computer which has received the authentication result or the like finally confirms personal identification, and then withdraws the merchandize credit from the bank account of the buyer that has been acquired from the buyer.

The second embodiment has exemplified a fingerprint authentication apparatus, but can also be applied to any object collation system using a method of authenticating an eye such as an iris, a pattern on the palm of a hand, or a face, as another method of image-sensing a living body and comparing the image with personal information in a database.

The code reader system and object collation system described in the above embodiments of the present invention are effective for downsizing and cost reduction necessary to available handy type devices, and image sensing units assembled in a portable telephone and PDA in the future.

The above embodiments of the present invention have exemplified a bar code reader and fingerprint authentication apparatus. However, the image processing apparatus of the present invention is not limited to them, and can also be applied to, e.g., a security camera which usually records an image at a low resolution and when detecting the presence of a moving object such as man, records the moving object at a high resolution.

In the first and second embodiments described above, even if low-resolution reading and high-resolution reading are mixed, the interval between reading of a signal in the field V1 from the sensor and reading of the field V2 is equal to the interval between reading of a signal in the field V3 and reading of the field V2.

Instead of the operation as shown in FIG. 8, the signal reading period of one frame may be kept constant regardless of resolution by inserting a period during which no 1-line period signal is read out, between reading of a 1-line signal from the sensor and reading of the next 1-line signal at a low resolution.

As has been described above, according to the present invention, image signals are read out from the sensor at the same interval regardless of whether the resolution is switched. Processed image signals can therefore be output without any frame memory or cumbersome correction.

### Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM, and computer network, such as LAN (local area network) and LAN, can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts in FIGS. 6 and 7, or the flowchart in FIG. 12 described in the embodiments.

The present invention is not limited to the above embodiments and various changes and modifications can be made within the spirit and scope of the present invention. Therefore to apprise the public of the scope of the present invention, the following claims are made.

What is claimed is:

1. An image sensing apparatus comprising:
a sensor which generates an image signal of an object;
an operation unit which, when signals of a plurality of frames of the object are read out from said sensor at a first resolution and a second resolution higher than the first resolution, operates said sensor so as to set intervals between read-out starts of image signals of the plurality of frames to be constant; and
a controller which performs control so as to execute at least one of exposure adjustment and focus adjustment on the basis of an image signal read out from said sensor at the first resolution, and to execute image processing on the basis of an image signal read out from said sensor at the second resolution under an adjusted condition.

2. The apparatus according to claim 1 further comprising a comparator which compares the image signal of the object from said sensor with a pre-acquired image signal of the object.

3. The apparatus according to claim 1 further comprising a light-emitting element array which irradiates the object, and a pad which aligns an arrangement direction of light-emitting elements of said light-emitting element array with a longitudinal direction of the object.

4. The apparatus according to claim 1 further comprising:
a processing unit which processes the image signal of the object from said sensor; and
a converter which converts the image signal of the object into information of the object,
wherein the image signal of the object as code information is processed by said processing unit, and the code information is converted into corresponding character information by said converter.

5. An image sensing apparatus comprising:
a sensor which generates an image signal of an object;
an operation unit which, when signals of a plurality of frames of the object are read out from said sensor at a first resolution and a second resolution higher than the first resolution, operates said sensor so as to set intervals between read-out starts of image signals of the plurality of frames to be constant; and
a controller which performs control so as to authenticate the object on the basis of an image signal read out from said sensor at the second resolution when the object cannot be authenticated based on an image signal read out from said sensor at the first resolution.

6. The apparatus according to claim 5 further comprising a comparator which compares the image signal of the object from said sensor with a pre-acquired image signal of the object.

7. The apparatus according to claim 5 further comprising a light-emitting element array which irradiates the object, and a pad which aligns an arrangement direction of light-emitting elements of said light-emitting element array with a longitudinal direction of the object.

8. The apparatus according to claim 5 further comprising:
a processing unit which processes the image signal of the object from said sensor; and
a converter which converts the image signal of the object into information of the object,
wherein the image signal of the object as code information is processed by said processing unit, and the code information is converted into corresponding character information by said converter.

9. An image sensing method of generating an image signal of an object by a sensor and processing the obtained image signal comprising the steps of:
when signals of a plurality of frames of the object are read out from the sensor at a first resolution and a second resolution higher than the first resolution, operating the sensor so as to set intervals between read-out starts of image signals of the plurality of frames to be constant; and
executing at least one of exposure adjustment and focus adjustment on the basis of an image signal read out from the sensor at the first resolution, and executing image processing on the basis of an image signal read out from the sensor at the second resolution under an adjusted condition.

10. The method according to claim 9 further comprising a step of comparing the image signal of the object from the sensor with a pre-acquired image signal of the object.

11. The method according to claim 9 further comprising the steps of:
processing the image signal of the object from the sensor; and
converting the image signal of the object into information of the object,
wherein the image signal of the object as code information is processed in the processing step, and the code information is converted into corresponding character information in the converting step.

12. An image sensing method of generating an image signal of an object by a sensor and processing the obtained image signal comprising the steps of:
when signals of a plurality of frames of the object are read out from the sensor at a first resolution and a second resolution higher than the first resolution, operating the sensor so as to set intervals between read-out starts of image signals of the plurality of frames to be constant;
authenticating the object on the basis of an image signal read out from the sensor at the first resolution; and
authenticating the object on the basis of an image signal read out from the sensor at the second resolution when the object cannot be authenticated based on an image signal read out from the sensor at the first resolution.

13. The method according to claim 12 further comprising a step of comparing the image signal of the object from the sensor with a pre-acquired image signal of the object.

14. The method according to claim 12 further comprising the steps of:
processing the image signal of the object from the sensor; and
converting the image signal of the object into information of the object,
wherein the image signal of the object as code information is processed in the processing step, and the code information is converted into corresponding character information in the converting step.

15. A computer program product comprising a computer usable medium having computer readable program code means embodied in said medium for generating an image signal of an object by a sensor and processing the obtained image signal said product including:
first computer readable program code means for, when signals of a plurality of frames of the object are read out from the sensor at a first resolution and a second resolution higher than the first resolution, operating the sensor so as to set intervals between read-out starts of image signals of the plurality of frames to be constant; and
second computer readable program code means for executing at least one of exposure adjustment and focus adjustment on the basis of an image signal read out from the sensor at the first resolution, and executing image processing on the basis of an image signal read out from the sensor at the second resolution under an adjusted condition.

16. A computer program product comprising a computer usable medium having computer readable program code means embodied in said medium for generating an image signal of an object by a sensor and processing the obtained image signal said product including:
first computer readable program code means for, when signals of a plurality of frames of the object are read out from the sensor at a first resolution and a second resolution higher than the first resolution, operating the sensor so as to set intervals between read-out starts of image signals of the plurality of frames to be constant;
second computer readable program code means for authenticating the object on the basis of an image signal read out from the sensor at the first resolution; and
third computer readable program code means for authenticating the object on the basis of an image signal read out from the sensor at the second resolution when the object cannot be authenticated based on an image signal read out from the sensor at the first resolution.
